(19) United States
(12) Patent Application Publication
(10) Pub. No.: US 2025/0375970 A1
(43) Pub. Date: Dec. 11, 2025

(54) METHOD FOR OPERATING A PRINTING APPARATUS, PRINTING APPARATUS AND SOFTWARE PRODUCT

(71) Applicant: Canon Production Printing Holding B.V., Venlo (NL)

(72) Inventors: Takahiro P. TERAYAMA, Venlo (NL); Thijs W. VERSLOOT, Venlo (NL); Matheus WIJNSTEKERS, Venlo (NL); Maikel A.J. HUYGENS, Venlo (NL)

(73) Assignee: Canon Production Printing Holding B.V., Venlo (NL)

(21) Appl. No.: 19/299,720

(22) Filed: Aug. 14, 2025

Related U.S. Application Data
(63) Continuation of application No. PCT/EP2024/054283, filed on Feb. 20, 2024.

(30) Foreign Application Priority Data
Feb. 22, 2023 (EP) 23157963.2

(51) Int. Cl. B41J 11/00; B41M 7/00

(52) U.S. Cl. CPC B41J 11/00212; B41J 11/00214; B41M 7/0081

(57) ABSTRACT

The present invention relates to a method for applying an image onto a receiving medium, wherein the image is applied onto the recording medium by depositing a UV-curable ink and the ink is irradiated with radiation, wherein the radiation comprises two types of UV radiation. The present invention further relates to a printing apparatus and a software product.

The present invention relates to a method for applying an image onto a receiving medium, wherein the image is applied onto the recording medium by depositing a UV-curable ink and the ink is irradiated with radiation, wherein the radiation comprises two types of UV radiation. The present invention further relates to a printing apparatus and a software product.

### BACKGROUND OF THE INVENTION

Methods for operating a printing apparatus using a radiation-curable ink are known in the art. Generally, such methods comprise the step of applying the radiation-curable ink onto a recording medium, e.g. by jetting droplets of the ink using an ink jet printer. After the ink has been applied onto the recording medium, the ink is hardened by irradiating the ink using a curing unit configured to in operation emit a suitable source of radiation, such as UV radiation. The source of radiation may be comprised in a curing unit. The curing unit may be a page-wide curing unit. An example of a printing apparatus comprising such page-wide curing unit is disclosed in EP 3481640.

When preparing a printed image, it is desired that the ink adheres well to the receiving medium, in order to obtain a robust image. However, it is often observed that the ink does not adhere well to the recording medium. This is also referred to as low adhesion of the ink to the recording medium.

Therefore a need exists for a method of printing wherein prints are prepared having good adhesion to the recording medium.

It is therefore an object of the present invention to provide a method of printing wherein prints are prepared having good adhesion to the recording medium. It is a further object of the invention to provide a printing apparatus that enables preparing prints having good adhesion to the recording medium.

### SUMMARY OF THE INVENTION

The object of the invention is achieved in a method for applying an image onto a receiving medium, the method comprising the steps of:
a) applying a predetermined pattern of a UV-curable ink onto a recording medium to form an image;
b) irradiating the UV-curable ink with UV radiation; the UV radiation comprising at least two types of UV radiation, the first type of UV-radiation having a first wavelength and the second type of UV-radiation having a second wavelength, the first wavelength being shorter than the second wavelength
wherein in step b,
   the ink is first irradiated with a first intensity of the first type of radiation and a second intensity of the second type of radiation, wherein the first intensity is greater than the second intensity.

The method may be performed using a printing apparatus. A printing apparatus is also referred to as printer. The printer may be configured to in printing operation apply a UV-curable ink. The UV-curable ink may be a UV-curable inkjet ink, for example a UV gel ink. Suitable types of radiation-curable inkjet inks including UV-curable inkjet inks are known in the art. Preferably, the printer may be an inkjet printer, configured to apply ink onto the recording medium by jetting droplets of ink onto the recording medium in a predetermined pattern to form an image.

The printing apparatus comprises a print unit. The print unit may be configured to in operation deposit a predetermined pattern of a UV-curable ink on a recording medium. In the method according to the present invention, in step a), a predetermined pattern of a UV-curable ink is applied onto a recording medium to form an image.

The print unit may comprise at least one inkjet print head configured to in operation jet ink onto the recording medium. The print head may be for example a thermal inkjet print head or a piezo electric inkjet print head. The printer may comprise a plurality of inkjet print heads. One type or color of ink may be used to form the image, but alternatively more than one type and/or color of ink may be used. A Cyan, a Magenta, a Yellow and a black ink may be used to form the image. In addition, one or more of a white ink, brown ink, grey ink, light magenta, light cyan, red, green, orange, purple ink may be used. Further, one or more of a primer composition, an overcoat composition and a metallic ink may be used. The print unit may be a page-wide print unit or may be a scanning print unit. A scanning print unit may be configured to in operation move in reciprocation in a scanning direction. The scanning direction may be perpendicular to a medium transport direction.

The printing apparatus may further comprise a medium support. The medium support may be configured to in operation support the recording medium. Optionally, the recording medium may be moved in a medium transport direction. The medium support may comprise a flat table. Optionally, the medium support may comprise an endless belt. The medium support may comprise holes for applying an underpressure. Applying an underpressure may fix the recording medium to the medium support.

Optionally, the printing apparatus may comprise medium transport unit. The medium transport unit may be configured to in operation move the recording medium relative to the printer in the medium transport direction.

The printing apparatus further comprises a curing unit. The curing unit is configured to in operation irradiate a recording medium provided with a UV-curable ink. By irradiating the UV-curable ink, a chemical reaction may occur in the UV-curable ink, which may result in curing or pre-curing of the fluid. The curing unit may be a scanning curing unit. Alternatively, the curing unit may be a page-wide curing unit. The page-wide array may extend in a first direction, the first direction being substantially perpendicular to a direction of relative recording medium transport. The recording medium may move with respect to the scanning print unit. The relative movement may be effected by moving at least one of the recording medium and print unit. The direction of relative movement of the print unit and the recording medium is the relative recording medium transport direction.

In the method according to the present invention, in step b), the UV-curable ink is irradiated with UV radiation; the UV radiation comprising at least two types of UV radiation, the first type of UV-radiation having a first wavelength and the second type of UV-radiation having a second wavelength, the first wavelength being shorter than the second wavelength.

UV-radiation is radiation is electromagnetic radiation. The wavelength of UV-radiation is in the range of 100 nm to 415 nm. The influence of UV-radiation on UV-curable inks may depend on the wavelength of the UV-radiation.

UV-C radiation is UV-radiation having a wavelength in the range of about 100 nm to about 280 nm. UV-B radiation is UV-radiation having a wavelength in the range of about 280 nm to about 315 nm. UV-A radiation is UV-radiation having a wavelength in the range of about 315 nm to about 415 nm. UV-C, UV-B and or UV-A radiation may be used in the present invention. The first and second type of radiation may be selected from the UV-C, UV-B and UV-A radiation. Optionally, both the first wavelength and the second wavelength may fall within the range of one of UV-C, UV-B or UV-A radiation, provided the first wavelength is shorter than the second wavelength.

In an embodiment, the intensity of the radiation may be the irradiance. Irradiance is the energy per unit time that strikes a unit horizontal area, where the typical unit is W m⁻². The first type of radiation may have a first irradiance, whereas the second type of radiation may have a second irradiance.

In an embodiment, the ink may be first irradiated in a first curing zone. The first curing zone may be an area on the recording medium. The first curing zone is the area where the ink deposited onto the recording medium is first irradiated. Upstream of the first curing zone, in the medium transport direction, the ink deposited on the recording medium may not receive radiation.

In an embodiment, the first wavelength may have a certain distribution. The second wavelength may also have a certain distribution. The wavelength may refer to the wavelength that has the highest intensity of all wavelength within said wavelength distribution.

In the method according to the present invention, in step b, the ink is first irradiated with a first intensity of the first type of radiation and a second intensity of the second type of radiation, wherein the first intensity is greater than the second intensity.

It was surprisingly found that this may result in improved adhesion of ink onto a recording media after curing of said ink.

In an embodiment, secondly, the ink is irradiated with a third intensity of the first type of radiation and a fourth intensity of the second type of radiation, wherein the fourth intensity is greater than the third intensity.

The intensities of the first type of UV-radiation and the second type of UV-radiation may vary with time. At first, the intensity of the first type of radiation may be higher than the intensity of the second type of radiation. Secondly, the intensity of the second type of radiation may be higher than the intensity of the first type of radiation. The second type of radiation, which has a wavelength larger than the first type of radiation, may lead to different curing behavior than the first type of radiation. For example, applying a relative high intensity of the second type of radiation after the start of the curing may result in improved through-cure of the ink layer. Through-cure is curing within the ink layer. In a printing system wherein the recording medium is moved in a medium transport direction during printing operation, at a first location the radiation has a first wavelength distribution and at a second location, the radiation has a second wavelength distribution. In the first wavelength distribution, the first intensity is greater than the second intensity and in the second wavelength distribution, the fourth intensity is greater than the third intensity. The first location may be upstream in the direction of medium transport with respect to the second location. Hence, when the recording medium is moved relative to the curing unit, the recording medium is first irradiated with a first wavelength distribution and later is irradiated with a second wavelength distribution. This may result in improved through-cure of the ink layer. Improved through-cure may result in improved adhesion of the ink layer.

In an embodiment, the ink is irradiated with a third intensity of the first type of radiation and a fourth intensity of the second type of radiation in a second curing zone. The second curing zone may be an area on the recording medium. The second curing zone may be position downstream of the first curing zone in the medium transport direction.

In an embodiment, at the start of the irradiation, the intensity of the first type of radiation is increased at a first rate and the intensity of the second type of radiation is increased at a second rate, wherein the first rate is at least three times higher than the second rate. At first, the intensity of the first type of radiation may be increased at a higher rate than the intensity of the second type of radiation. Thus, in an early stage of the curing process, the ink may receive a relatively high doses of the first type of radiation and a relatively low doses of the second type of radiation. This may result in improved adhesion of the ink to the recording medium.

In a further embodiment, the intensity of the UV-radiation may be low at the start of the irradiation. This intensity may be increased in a later phase of the irradiation.

In an embodiment, the intensity of the second type of radiation is zero.

When the ink applied onto the recording medium first receives radiation, the radiation may not comprise the second type of radiation. In the case, the curing process may be started using the first type of radiation and not the second type of radiation.

In an embodiment, the UV-curable ink is a gelling UV-curable ink.

A special class of UV-curable inkjet ink compositions are gelling UV-curable inkjet ink compositions. These inks are fluid at elevated temperature and become solid—even if not yet cured—at lower temperatures. These inks are typically jetted at elevated temperatures. Gelling UV-curable inks may become solid or semi-solid upon cooling down on a recording medium, e.g. a sheet of paper. As a result, spread of a droplet of ink on the recording medium may be decreased and color bleeding may be prevented. Gelling UV-curable inkjet ink may be jetted at elevated temperature and may undergo a rapid increase in viscosity when being jetted onto a recording medium. Because of the increase in viscosity, the droplets of ink jetted onto the recording medium may not spread much and hence, color bleeding may be prevented even if the ink composition is not immediately cured after being applied onto the recording medium. The gelling behavior may be provided by adding a suitable gellant to the UV-curable ink composition.

When using a UV-gelling ink, it may be possible to allow a time interval between applying the ink onto the recording medium and irradiating the ink. Hence, it may be more easy to control the timing of the irradiation step. Further, using a gelling UV-curable ink may enable to apply a plurality of layers before the ink is irradiated.

In an embodiment, the second wavelength is in the range of 375 nm to 415 nm. UV-radiation in the range of 375 nm to 415 nm may efficiently induce a curing reaction in the ink applied onto the recording medium. UV-radiation in the range of 375 nm to 415 nm may improve surface curing of the ink. Curing the surface may be hampered by oxygen inhibition. Therefore, it may be advantageous to use UV-radiation in the range of 375 nm to 415 nm, as this may result in a printed image having sufficient surface curing.

In an embodiment, the first wavelength is in the range of 100 nm to 315 nm. UV radiation having a wavelength in the range of 100 nm to 315 nm is a type of radiation that may efficiently induce a polymerization reaction in the ink. This type of radiation has a high energy, compared to types of UV radiation having a longer wavelength. Without wanting to be bound to any theory, it is believed that this highly energetic type of UV radiation may efficiently induce a polymerization reaction in the ink, leading to good curing properties.

In an embodiment, the first wavelength is in the range of 350 nm to 395 nm. UV radiation having a wavelength in the range of 100 nm to 315 nm is another type of radiation that may efficiently induce a polymerization reaction in the ink.

In an embodiment, the difference between the first wavelength and the second wavelength is from 5 nm to 50 nm.

The difference in wavelength may be in the range of 5 nm to 50 nm. If the difference in wavelength is less than five nanometers, the difference in curing behavior induced by the two types of radiation may be too small. A difference in wavelength of between 5 nm and 50 nm may efficiently induce curing in the ink.

In an embodiment, in step a), the predetermined pattern comprises a plurality of ink layers.

A printed image may comprise a plurality of layers of ink. Ink may be applied in a plurality of swaths, wherein a new layer of ink is applied onto a previously applied layer of ink. The layers may together form an image. Alternatively, the different layers may have a different appearance. For example, a background layer may be formed and an image layer may be formed. The image layer may be applied on top of the background layer or the background layer may be applied on top of the image layer. The background layer may be formed by a single background color, for example white. The image layer may be formed by a plurality of differently colored inks. Preferably, all ink layers are applied onto the recording medium before the ink is cured. The use of UV gelling ink allows to apply relatively thick layers onto a recording medium, before curing the ink. Thick layers of ink are difficult to cure, as the radiation needs to penetrate through a thick layer of ink to cure the entire layer, including the ink-recording medium interface, the bulk of the layer and the ink-air interface. The present invention allows to efficiently cure the entire layer of ink and creating print s having good adhesion.

In an aspect of the invention, a printing apparatus is provided, the printing apparatus comprising:
at least one print unit for depositing a UV-curable ink;
a curing unit;
a recording medium support for supporting a recording medium;
a control unit configured to in operation control the printing apparatus to perform a method according to the present invention.

The printer is thus configured to perform a method according to the present invention.

In a further aspect of the invention, a software product is provided, the software product comprising program code on a non-transitory machine-readable medium, wherein the program code, when loaded into a controller of a printing apparatus with at least one printing unit for depositing a UV-curable ink, a curing unit and a control unit, causes the controller to perform a method according to the present invention.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic perspective view of a first example of a printing system according to the present invention in a first printing mode;

FIG. 2 is a schematic perspective view of a second example of a printing system according to the present invention in a second printing mode;

FIG. 3 is a schematic diagram of a control unit of a reprographic system according to FIG. 1 or 2;

FIG. 4 schematically shows a first example of the method according to the present invention.

FIG. 5 schematically shows a second example of the method according to the present invention.

FIG. 6A schematically shows a third example of the method according to the present invention.

FIG. 6B schematically shows the intensity of the first type of radiation and the second type of radiation, respective at different positions, according to the third example shown in FIG. 6A.

FIG. 7A schematically shows a fourth example of the method according to the present invention.

FIG. 7B schematically shows the intensity of the first type of radiation and the second type of radiation, respective at different positions, according to the fourth example shown in FIG. 7A.

FIG. 8A is a schematic view of curing array in accordance with a fifth example of the present invention.

FIG. 8B is a schematic view of a page-wide curing array in accordance with a sixth example of the present invention

FIG. 9 schematically shows a seventh example of the method according to the present invention.

In the drawings, same reference numerals refer to same elements.

### DETAILED DESCRIPTION OF THE PREFERRED EMBODIMENTS

The present invention will now be described with reference to the accompanying drawings, wherein the same reference numerals have been used to identify the same or similar elements throughout the several views.

### Printing System

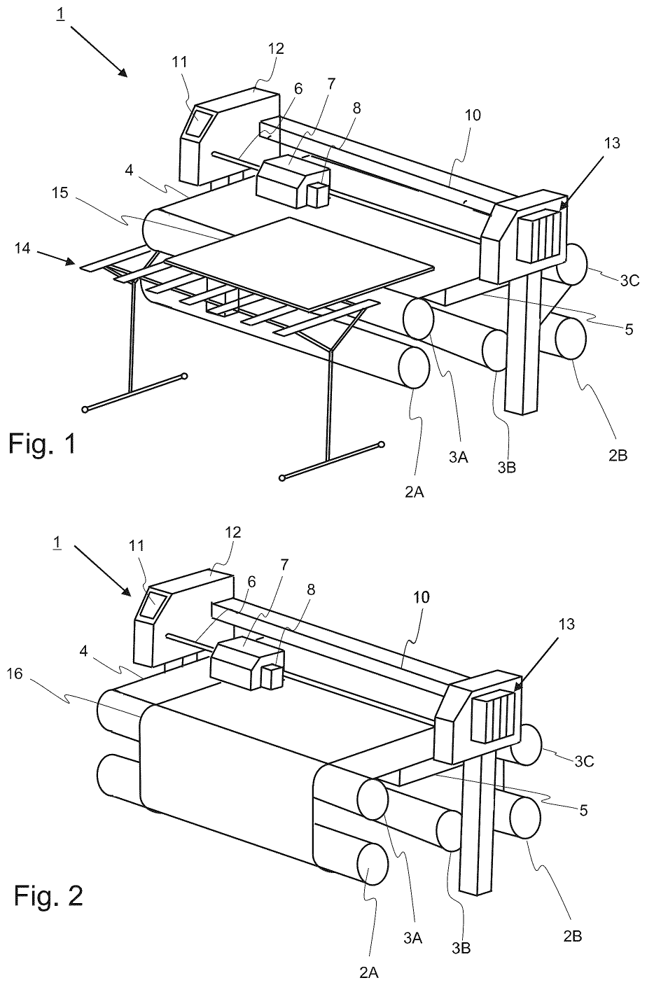

FIG. 1 shows a printing apparatus. A printing apparatus is also known as printer. The printing apparatus 1 comprises an scanning printing unit 7 for printing on a recording medium 15. The recording medium 15 in FIG. 1 is a relatively rigid substrate, such as a panel. The recording medium 15 is supplied from a media input unit 14, which may be configured for storing a plurality of such print media 15 and supplying these to the printer 1. The printer 1 comprises a medium support 4. Printer 1 may further comprise transport means for receiving and transporting the recording medium 15 along the scanning printing unit 7. In FIG. 1, the medium support is embodied as an endless belt 4. The endless belt is an endless transport belt 4 supported on a plurality of support rollers 3A, 3B, 3C. At least one of the support rollers 3A, 3B, 3C is provided with driving means for moving the belt 4. The belt 4 is therefore configured to support and transport the recording medium. Additionally, one or more than one of the support rollers 3A, 3B, 3C may be configured to be moved and/or tilted to adjust and control the lateral position of the belt 4. The scanning printing unit 7 may be provided with a sensor 8, such as a CCD camera, to determine the relative position of belt 4 and/or the recording medium 15. Data from said sensor 8 may be applied to control the position of the belt 4 and/or the recording medium 15. The belt 4 is further provided with through-holes and a suction box 5 in connection with a suction source (not shown), such that an underpressure may be applied to the recording medium 15 via the through-holes in the belt 4. The underpressure adheres the recording medium 15 flatly to the belt 4 and prevents displacement of the recording medium 15 with respect to the belt 4. Due to this holding the belt 4 is able to transport the recording medium 15. It will be appreciated that other suitable transport means, such as rollers, steppers, etc, may alternatively be applied. The recording medium 15 may be transported stepwise and/or in continuous movement. The scanning printing unit 7 is configured to translate along a first guide beam 6 in a scanning direction. The scanning direction is perpendicular to the direction in which the print medium is transported by the belt 4. The scanning printing unit 7 holds a plurality of print heads (not shown), which are configured to jet a plurality of different marking materials (different colors of ink, primers, coatings, etc.) on the recording medium 15. Each marking material for use in the scanning printing unit 7 is stored in one of a plurality of containers arranged in fluid connection with the respective print heads for supplying marking material to said print heads to print an image on the recording medium 15.

The application of the marking material, such as the radiation-curable ink from the printing units is performed in accordance with data provided in the respective print job. The printing unit may comprise one or more inkjet print heads. The timing by which the droplets of marking material are released from the one or more print heads determines their position on the recording medium 15. The timing may be adjusted based on the position of the scanning printing unit 7 along the first guide beam 6. The above mentioned sensor 8 may therein be applied to determine the relative position and/or velocity of the scanning printing unit 7 with respect to the recording medium 15. Based upon data from the sensor 8, the release timing of the marking material may be adjusted.

Upon ejection of the marking material, some marking material may be spilled and stay on a nozzle surface of the print heads. The marking material present on the nozzle surface, may negatively influence the ejection of droplets and the placement of these droplets on the recording medium 15. Therefore, it may be advantageous to remove excess of marking material from the nozzle surface. The excess of marking material may be removed for example by wiping with a wiper and/or by application of a suitable anti-wetting property of the surface, e.g. provided by a coating.

The marking materials may require treatment to properly fixate them on the print medium. Thereto, a fixation unit is provided downstream of the scanning printing unit 7. The fixation unit may emit radiation to facilitate the marking material fixation process. In the example of FIG. 1, the fixation unit is page-wide curing array 10. The page-wide curing array 10 extends in the main scanning direction. The page-wide curing array does not move in operation in the main scanning direction. The page-wide array may move in the direction of medium transport, which is a direction perpendicular to the scanning direction. In an alternative embodiment (not shown), the fixation unit may be a scanning fixation unit, that in operation moves in reciprocation in the scanning direction. The page-wide curing array 10 is configured to in operation emit radiation of certain frequencies, which interacts with the marking materials, for example UV light in case of UV-curable inks. Optionally (not shown), the scanning printing unit 7 may be provided with a further fixation unit on the same carriage which holds the print heads. This further fixation unit can be used to (partially) cure and/or harden the marking materials, independent of or interaction with the page-wide curing array 10.

After printing and fixation, the recording medium 15 is transported to a receiving unit (not shown). The receiving unit may comprise a take-up roller for winding up the recording medium 15, a receiving tray for supporting sheets of recording medium 15, or a rigid media handler, similar to the media input unit 14. Optionally, the receiving unit may comprise processing means for processing the medium 8, 9 after printing, e.g. a post-treatment device such as a coater, a folder, a cutter, or a puncher.

Printing apparatus 1 furthermore comprises a user interface 11 for receiving print jobs and optionally for manipulating print jobs. The local user interface unit 11 is integrated to the print engine and may comprise a display unit and a control panel. Alternatively, the control panel may be integrated in the display unit, for example in the form of a touch-screen control panel. The local user interface unit 11 is connected to a control unit 12 connected to the printer 1. The control unit 12, for example a computer, comprises a processor adapted to issue commands to the printer 1, for example for controlling the print process. The printer 1 may optionally be connected to a network. The connection to the network can be via cable or wireless. The printer 1 may receive printing jobs via the network. Further, optionally, the control unit 12 of the printer 1 may be provided with an input port, such as a USB port, so printing jobs may be sent to the printer 1 via this input port.

### Hybrid Printing System

The printer 1 in FIG. 1 is a so-called hybrid printer, capable of handling both flexible media and rigid substrates. In FIG. 1, the printer 1 operates in a first print mode, wherein the printer 1 is configured for transporting rigid substrates, such as the recording medium 15. Such rigid print media 15 may be panels, for example panels for doors or walls, corrugated media, plates formed of plastic or metal, etc. To handle these rigid print media 15, the printer 1 in FIG. 1 is configured with a substantially linear transport path: from the media input device 14, the recording medium 15 moves forward along the scanning printing unit 7 at a at substantially constant height. The media input unit 14 and the receiving unit are positioned at the level of the medium support surface of the belt 4. In FIG. 2, a flexible web medium 16 is supplied to the printer 1, which web medium 16 may be composed of e.g. paper, label stock, coated paper, plastic or textile. The web medium 16 is supplied from the input roller 2A and extends across the belt 4 to the take-up roller 2B, where the web medium 16 is re-wound. The printer 1 is configured to swiftly and efficiently switch between print modes.

### Control

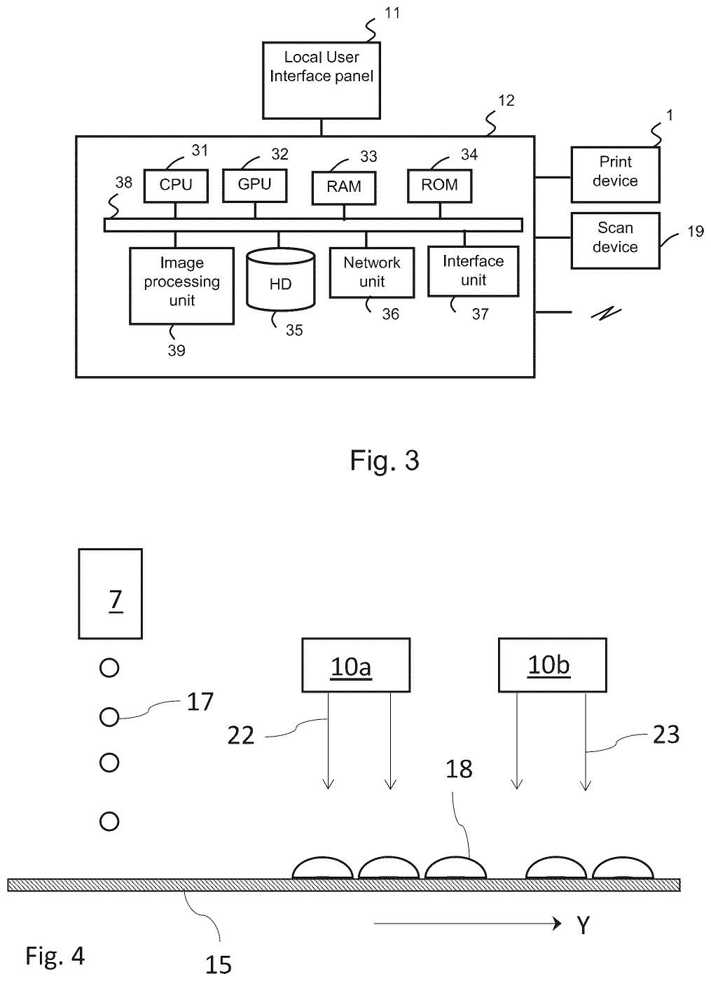

An embodiment of the control unit 12 is in more detail presented in FIG. 3. As shown in FIG. 3, the control unit 12 comprises a Central Processing Unit (CPU) 31, a Graphical Processor Unit (GPU) 32, a Random Access Memory (RAM) 33, a Read Only Memory (ROM) 34, a network unit 36, an interface unit 37, a hard disk (HD) 35 and an image processing unit 39 such as a Raster Image Processor (RIP). The aforementioned units 31-37 are interconnected through a bus system 38. However, the control unit 12 may also be a distributed control unit.

The CPU 31 controls the printing system 1 in accordance with control programs stored in the ROM 34 or on the HD 35 and the local user interface panel 5. The CPU 31 also controls the image processing unit 39 and the GPU 32. The ROM 34 stores programs and data such as boot program, set-up program, various set-up data or the like, which are to be read out and executed by the CPU 31. The hard disk 35 is an example of a non-volatile storage unit for storing and saving programs and data which make the CPU 31 execute a print process to be described later. The hard disk 35 also comprises an area for saving the data of externally submitted print jobs. The programs and data on the HD 35 are read out onto the RAM 33 by the CPU 31 as needed. The RAM 33 has an area for temporarily storing the programs and data read out from the ROM 34 and HD 35 by the CPU 31, and a work area which is used by the CPU 31 to execute various processes. The interface unit 37 connects the control unit 12 to the client devices, such as scan device 19 and to the printing system 1. The network unit 36 connects the control unit 12 to the network N and is designed to provide communication with the workstations (not shown) and with other devices 19 reachable via the network N. The image processing unit 39 may be implemented as a software component running on an operation system of the control unit 12 or as a firmware program, for example embodied in a field-programmable gate array (FPGA) or an application-specific integrated circuit (ASIC). The image processing unit 39 has functions for reading, interpreting and rasterizing the print job data. Said print job data contains image data to be printed (i.e. fonts and graphics that describe the content of the document to be printed, described in a Page Description Language or the like), image processing attributes and print settings.

FIG. 4 schematically shows a first example of the method according to the present invention. A print unit 7 is provided configured to jet droplets 17 of ink onto a receiving medium 15. Only one print unit 7 is depicted in FIG. 4, but in practice, a plurality of print heads may be provided, optionally jetting different colors of ink. Each one of the droplets 17, when jetted by the print unit 7 is in the fluid state. To bring and keep the ink in the fluid state, the print unit 7 may be provided with heating means (not shown). The ink may start cooling down after is has been ejected from the print unit 7 through a nozzle (not shown). The ink may undergo a phase change, because of the cooling of the ink. The receiving medium 15 onto which droplets 17 of the ink are applied is moved in direction Y, which is the recording medium transport direction. In case a scanning ink jet process is used, for example the one shown in FIG. 1 and FIG. 2, the recording medium transport direction is often referred to as sub scanning direction. After the droplets of ink have been applied the droplets may continue to cool down and a phase change may occur, which results in the formation of immobilized droplets 18. The immobilized droplets 18 are transported together with the receiving medium 15 in the recording medium transport direction Y. Thereby, the immobilized droplets 18 are moved underneath the first source of UV radiation 10a. The first source of UV radiation 10a emits a first type of radiation, schematically depicted as rays of radiation 22. The radiation emitted by the first source 10a may have a first intensity. The immobilized droplets 18 irradiated by the rays 22 of the radiation emitted by the first source of radiation 10a.

After the droplets 18 have been irradiated by the first source of radiation 10a, the droplets are moved underneath a second source of UV radiation 10b. This second source of UV radiation 10b emits a second type of radiation, schematically depicted as rays of radiation 23. The radiation emitted by the second source 10b may have a second intensity, lower than the first intensity. The immobilized droplets are further cured by the rays 23 of the radiation emitted by the second source of radiation 10b. Upon further curing the droplets 18, the droplets may be fixed onto the receiving medium 15 and may form a robust image.

The type of the first source of UV radiation 10a and the second source of UV radiation 10b may be suitably selected.

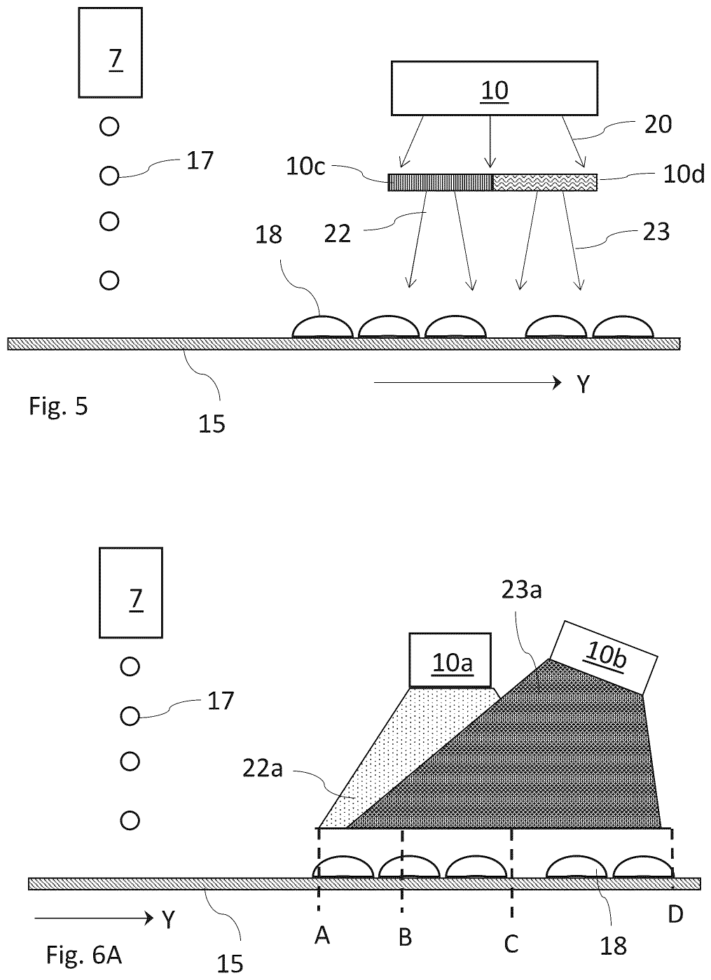

FIG. 5 schematically shows a second example of the method according to the present invention. The third example differs from the first example in the nature of the first and second source of radiation. The source of radiation according to the third example is an assembly of a general source of UV radiation 10 and a filter. A first filter 10c and a second filter 10d are provided. The first and the second filter 10c, 10d may be e.g. optical filters. Each one of the filters 10c, 10d absorbs part of the radiation emitted by the general source of UV radiation 10 and transmits part of the UV radiation emitted by the general source of UV radiation 10. Part of the beam of radiation, schematically depicted as rays of radiation 20, emitted by the general source of UV radiation 10 passes through the first filter 10c, another part of the beam passes through the second filter 10d. The part of the beam that passes through the first filter 10c provides a first beam of radiation, schematically depicted as rays of radiation 22. The radiation in the first beam of radiation has a first wavelength and a first intensity.

Adjacent to the first filter 10c, the second filter 10d is provided. The part of the beam emitted by the general source of radiation 10 that passes through the second filter 10d provides a second beam of radiation, schematically depicted as rays of radiation 23. The radiation in the second beam of radiation has a second wavelength and a second intensity. Thus, the first filter 10c and the second filter 10d may each absorb a part of the radiation emitted by the general source of radiation 10, thereby generating two different beams of radiation, each beam having a wavelength. The first filter 10c is provided upstream in the medium transport direction compared to the second filter 10d. Hence, droplets of ink that are applied on the receiving medium 15 and are immobilized, first pass underneath the first filter 10c and are thereby irradiated by the first type of radiation. Afterwards, the droplets 18 pass underneath the second filter 10d and are then irradiated by the second type of radiation.

Hence, in the present embodiment the first source of radiation and the second source of radiation are suitably embodied by providing a general source of radiation 10 and a first and a second filter 10c, 10d.

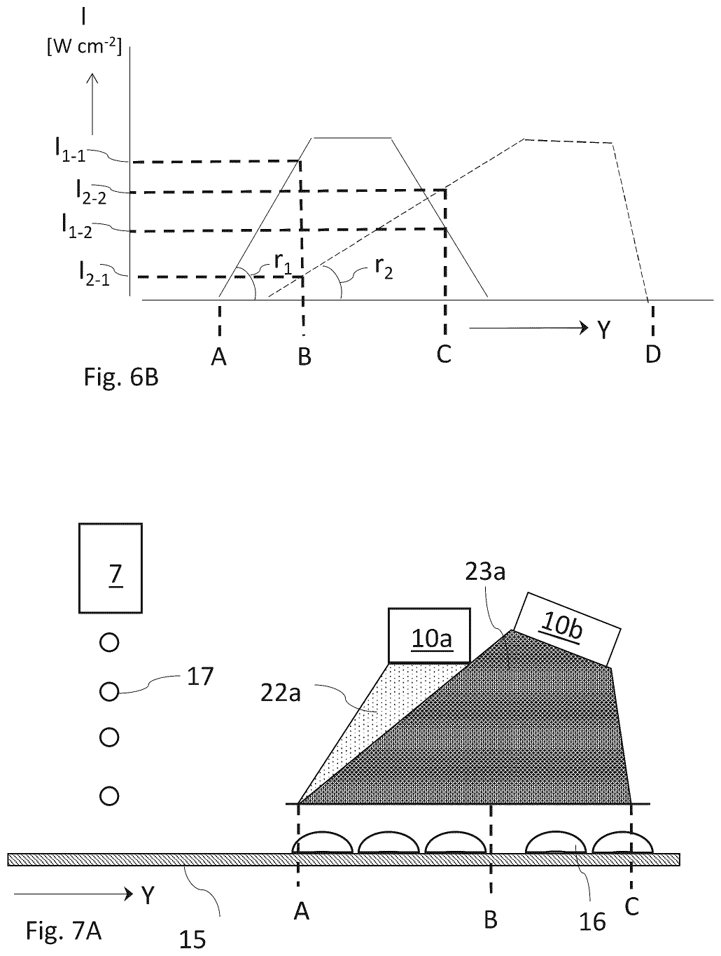

FIG. 6A schematically shows a third example of the method according to the present invention. A first source of radiation 10a is provided, as well as a second source of radiation 10b. The first beam of radiation 22a emitted by the first source of radiation is divergent; i.e. the diameter of the beam increases with increasing distance from the source of radiation 10a. The radiation emitted by the first source of radiation 10a is a first type of radiation. Also the second beam 23a emitted by the second source of radiation is divergent. The radiation emitted by the second source of radiation 10b is a second type of radiation. The first beam 22a and the second beam 23a irradiate the receiving medium 15 and the droplets 18 deposited thereon. The droplets form an ink layer. When the droplets 18 are moved in the paper transport direction, they are first irradiated by the first source of radiation 10a. Irradiation by the first source of radiation 10a starts at point A. In printing operation, the recording medium 15 and the curing units 10a, 10b move with respect to one another in direction Y. A certain position on a recording medium will first pass point A, then point B, then point C and afterwards will pass point D.

FIG. 6B schematically shows the intensity of the first type of radiation and the second type of radiation, respective at different positions, according to the third example shown in FIG. 6A. Point A marks a first curing zone. At point A, the ink is irradiated by the first beam 22a. Hence, the ink receives the first type of radiation but does not receive the second type of radiation. The first type of radiation is increased at a rate r₁ at the start of the radiation (point A).

At point B, the ink is irradiated with both the first type of radiation and the second type of radiation. The intensity of the first type of radiation is I₁₋₁, whereas the intensity of the second type of radiation is I₂₋₁. At point B, the intensity of the first type of radiation I₁₋₁ is higher than the intensity of the second type of radiation I₂₋₁.

Point C marks the second curing zone. At point C, like at point B, the ink is irradiated with both the first type of radiation and the second type of radiation. At point C, the intensity of the first type of radiation I₁₋₂ is higher than the intensity of the second type of radiation I₂₋₂.

In between point C and D, the intensity of the first type of radiation is reduced to zero. At point D, also the intensity of the second type of radiation is zero.

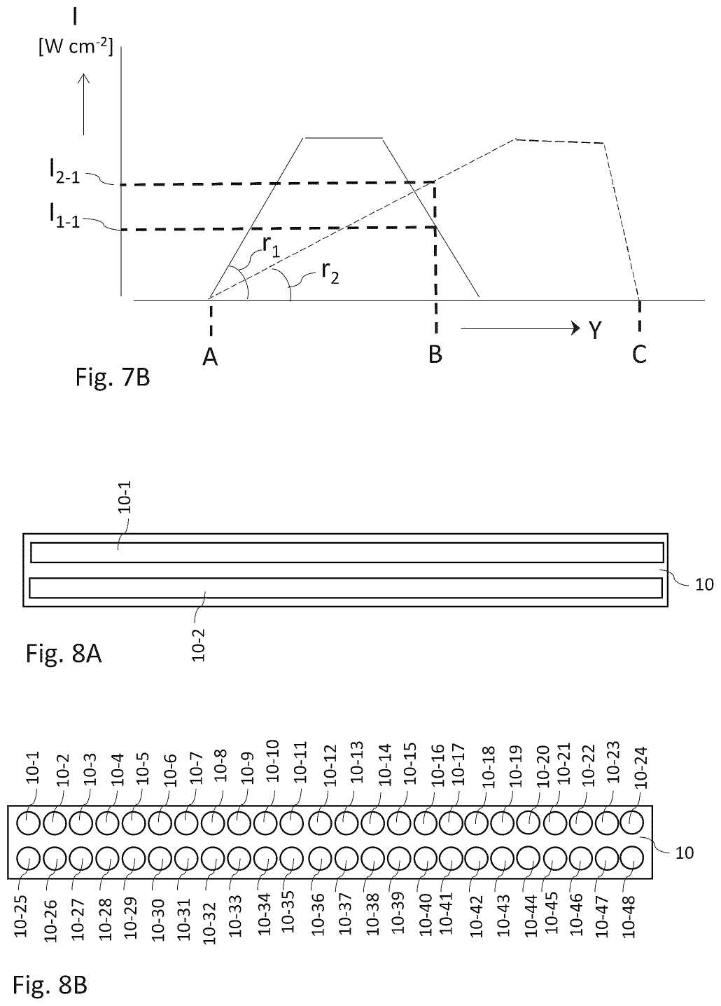

FIG. 7A schematically shows a fourth example of the method according to the present invention. Like in the example shown in FIG. 7A, a first source of radiation 10a is provided, as well as a second source of radiation 10b. The first beam of radiation 22a emitted by the first source of radiation is divergent; i.e. the diameter of the beam increases with increasing distance from the source of radiation 10a. The radiation emitted by the first source of radiation 10a is a first type of radiation. Also the second beam 23a emitted by the second source of radiation is divergent. The radiation emitted by the second source of radiation 10b is a second type of radiation. The first beam 22a and the second beam 23a irradiate the receiving medium and the droplets 18 deposited thereon. The droplets form an ink layer. When the droplets 18 are moved in the paper transport direction, they are first irradiated by the first source of radiation 10a. Irradiation by the first source of radiation 10a and by the second source of radiation 10b starts at point A. In printing operation, the recording medium and the curing units move with respect to one another in direction Y. A certain position on a recording medium will first pass point A, then point B, then point C and afterwards will pass point D.

FIG. 7B schematically shows the intensity of the first type of radiation and the second type of radiation, respective at different positions, according to the fourth example shown in FIG. 7A. At point A, the ink is irradiated by the first beam 22a and the second beam 23a. Hence, the ink receives the first type of radiation as well as the second type of radiation. At the start of the radiation (point A), the first type of radiation is increased at a rate r₁, whereas the second first type of radiation is increased at a rate r₂, wherein the rate r₁ is higher than the second rate r₂.

At point B, the ink is irradiated with both the first type of radiation and the second type of radiation. The intensity of the first type of radiation is I₁₋₁, whereas the intensity of the second type of radiation is I₂₋₁. At point B, the intensity of the first type of radiation I₁₋₁ is lower than the intensity of the second type of radiation I₂₋₁.

In between point B and C, the intensity of the first type of radiation is reduced to zero. At point C, also the intensity of the second type of radiation is zero.

FIG. 8A is a schematic view of curing array in accordance with a fifth example of the present invention. The page-wide curing array 10 comprises two radiation emitting elements; a first radiation emitting element 10-1 and a second radiation emitting element 10-2. Optionally, the first and second radiation emitting elements 10-1, 10-2 may be individually controllable. The first radiation emitting element 10-1 is configured to in operation emit a first type of radiation. The second radiation emitting element 10-2 is configured to in operation emit a second type of radiation. The curing array 10 may be positioned such, that in printing operation the ink deposited onto the recording medium is first irradiated with the first type of radiation and subsequently, is irradiated by the second type of radiation.

FIG. 8B is a schematic view of a page-wide curing array in accordance with a sixth example of the present invention. The page-wide curing array 10 comprises a plurality of LED elements 10-1, 10-2, 10-3, . . . , 10-48. The LED elements 10-1, 10-2, 10-3, . . . , 10-48 according to the example shown in FIG. 6B are positioned in two rows. In a first row, the LED elements 10-1 to 10-24 are positioned and in a second row, LED elements 10-25 to 10-48 are positioned. Each of the individual LED elements 10-1, 10-2, 10-3, . . . , 10-48 can be switched on or off independently form the other LED elements 10-1, 10-2, 10-3, . . . , 10-48. The LED elements 10-1-10-24 of the first row are configured to in operation emit radiation having a first wavelength, whereas the LED elements 10-25-10-48 of the second row are configured to in operation emit radiation having a second wavelength. The curing array 10 may be positioned such, that in printing operation the ink deposited onto the recording medium is first irradiated with the first type of radiation and subsequently, is irradiated by the second type of radiation.

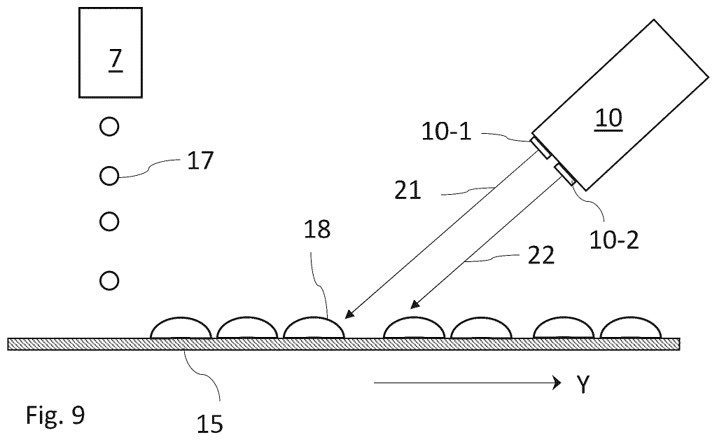

FIG. 9 schematically shows a seventh example of the method according to the present invention. A print unit 7 is provided configured to jet droplets 17 of ink onto a receiving medium 15. The ink is preferably a UV gel ink. Only one print unit 7 is depicted in FIG. 9, but in practice, a plurality of print heads may be provided, optionally jetting different colours of ink. Each one of the droplets 17, when jetted by the print unit 7 is in the fluid state. To bring and keep the ink in the fluid state, the print unit 7 may be provided with heating means (not shown). The ink may start cooling down after it has been ejected from the print unit 7 through a nozzle (not shown). The ink may undergo a phase change, because of the cooling of the ink. The receiving medium 15 onto which droplets 17 of the ink are applied is moved in direction Y, which is the recording medium transport direction. In case a scanning ink jet process is used, for example the one shown in FIG. 1 and FIG. 2, the recording medium transport direction is often referred to as sub scanning direction. After the droplets of ink have been applied, the droplets may continue to cool down and a phase change may occur, which results in the formation of immobilized droplets 18. The immobilized droplets 18 are transported together with the receiving medium 15 in the recording medium transport direction Y. Thereby, the immobilized droplets 18 are moved underneath the curing unit 10. The page-wide curing array 10 comprises two radiation emitting elements; a first radiation emitting element 10-1 and a second radiation emitting element 10-2. The first radiation emitting element 10-1 emits a first type of radiation, schematically depicted by arrow 21. The first type of radiation may have a first intensity. The second radiation emitting element 10-2 emits a second type of radiation, schematically depicted by arrow 22. The second type of radiation may have a second intensity. When the recording medium 15 provided with ink droplets 18 and the curing unit 10 move relative to one another in the medium transport direction Y, the ink droplets are first irradiated with the first type of radiation 21 and subsequently irradiated with the second type of radiation 22. Optionally, there may be overlap between the first type of radiation and the second type of radiation. Hence, when the ink droplets 18 first receive radiation, the ink droplets 18 receive the first type of radiation at a higher intensity than the second type of radiation.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims are herewith disclosed. Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

1. Method for applying an image onto a receiving medium, the method comprising the steps of:
a) Applying a predetermined pattern of a UV-curable ink onto a recording medium to form an image;
b) irradiating the UV-curable ink with UV radiation; the UV radiation comprising at least two types of UV radiation, the first type of UV-radiation having a first wavelength and the second type of UV-radiation having a second wavelength, the first wavelength being shorter than the second wavelength
wherein in step b,
the ink is first irradiated with a first intensity of the first type of radiation and a second intensity of the second type of radiation, wherein the first intensity is greater than the second intensity.

2. Method according to claim 1, wherein secondly, the ink is irradiated with a third intensity of the first type of radiation and a fourth intensity of the second type of radiation, wherein the fourth intensity is greater than the third intensity.

3. Method according to claim 1, wherein at the start of the irradiation, the intensity of the first type of radiation is increased at a first rate and the intensity of the second type of radiation is increased at a second rate, wherein the first rate is at least three times higher than the second rate.

4. Method according to claim 1, wherein at the start of the irradiation, the intensity of the second type of radiation is zero.

5. Method according to claim 1, wherein the UV-curable ink is a gelling UV-curable ink.

6. Method according to claim 1, wherein the second wavelength is in the range of 375 nm to 415 nm.

7. Method according to claim 6, wherein the first wavelength is in the range of 100 nm to 315 nm.

8. Method according to claim 6, wherein the first wavelength is in the range of 350 nm to 395 nm.

9. Method according to claim 8, wherein the difference between the first wavelength and the second wavelength is from 5 nm to 50 nm.

10. Method according to claim 5, wherein in step a), the predetermined pattern comprises a plurality of ink layers.

11. Printing apparatus comprising:
at least one print unit for depositing a UV-curable ink;
a curing unit;
a recording medium support for supporting a recording medium;
a control unit configured to in operation control the printing apparatus to perform a method according claim 1.

12. A software product comprising program code on a non-transitory machine-readable medium, wherein the program code, when loaded into a controller of a printing apparatus with at least one printing unit for depositing a UV-curable ink, a curing unit and a control unit, causes the controller to perform a method according to claim 1.
